(19) United States
(12) Patent Application Publication
(10) Pub. No.: US 2026/0274588 A1
(43) Pub. Date: Sep. 17, 2026

(54) SIDE-BY-SIDE ELIMINATOR WITH SLEEVE COVERED ROLLERS

(71) Applicant: Lewco, Inc., Sandusky, OH (US)

(72) Inventors: Gerald T. Guerra, Sandusky, OH (US); Albert E. Sparling, Ossineke, MI (US); Mark Wellington Bosley, Johns Island, SC (US); Ryan Kenny, Richmond, VA (US); Nathan Cole Feaser, Carlisle, PA (US)

(21) Appl. No.: 19/567,223

(22) Filed: Mar. 15, 2026

Related U.S. Application Data
(60) Provisional application No. 63/772,688, filed on Mar. 16, 2025.

(51) Int. Cl. B65G 47/51; B65G 37/00; B65G 39/07; B65G 39/10

(52) U.S. Cl. CPC B65G 47/5145; B65G 37/00; B65G 39/07; B65G 39/10; B65G 2207/14

(57) ABSTRACT

A side-by-side eliminator conveying system includes a guardrail, a first conveyor, and a second conveyor. The guardrail includes a vertical side wall. The first conveyor is adjacent to the guardrail, and includes a first conveying surface perpendicular to the vertical side wall. The first conveying surface has a first inner edge and a first outer edge. The first inner edge is adjacent to the vertical side wall. The second conveyor includes a second conveying surface perpendicular to the vertical side wall. The second conveying surface includes a second inner edge and a second outer edge. The second inner edge is adjacent to the first outer edge of the first conveying surface. The second conveyor includes a series of driven rollers, where a roller is within at least a first sleeve and a second sleeve, which are configured to rotate independently of the roller.

### RELATED APPLICATION

This application claims priority to U.S. Provisional Patent Application No. 63/772,688, filed on March 16, 2025, and entitled “SIDE-BY-SIDE ELIMINATOR WITH SLEEVE COVERED ROLLERS,” the entirety of which is incorporated herein by reference.

### BACKGROUND

Conveyor systems can be used in various commercial and manufacturing applications to transport packages between different locations. Conventional conveyor systems commonly convey large numbers of packages at high speed. The packages conveyed can have various sizes, weights, shapes, rigidities, and so forth.

Problems can occur in a conveyor system with scanning and separating packages which travel through the conveyor system in bulk as opposed to in a single file line. Thus, it is desired to arrange a bulk flow of packages into a single file line to mitigate issues with subsequent scanning and sorting of the packages. A package singulation system within an overall conveyor system can attempt to align packages against a wall in an effort to align the packages in a single file line. By way of example, a package singulation system can use a plurality of driven rollers or belts whose axes extend obliquely relative to a direction of conveyance to cause the packages to be displaced laterally in an attempt to align the packages one behind another.

A bulk flow of packages, which are randomly arranged, can be inputted to a package singulation system. The package singulation system can attempt to arrange the packages in a single file line as the packages are conveyed in the direction of travel. However, the package singulation system may be unsuccessful in aligning a subset of the packages in a single file line. For instance, some of the packages may be separated laterally from the single file line (e.g., at a distance from the wall of the package singulation system). Accordingly, a downstream conveying system (e.g., a side-by-side eliminator) within the overall conveyor system can receive the stream of packages from the package singulation system and separate the packages in the single file line from the packages that are laterally separated from the single file line. For instance, a conventional side-by-side eliminator conveying system can remove the packages that are laterally separated from the single file line and recirculate such packages to an earlier portion of the overall conveyor system for another opportunity to be aligned as part of the single file line.

However, conventional side-by-side eliminator conveying systems can be complex and costly. For instance, some conventional side-by-side eliminator conveying systems include three or more conveyors used to laterally separate the packages that are outside of the single file line while allowing the packages in the single file line to be longitudinally conveyed; such systems oftentimes include three or more motors, power transmissions, controls, and so forth. Moreover, the conventional side-by-side eliminator conveying systems can be difficult to tune to account for different types of packages being conveyed.

### SUMMARY

The following is a brief summary of subject matter that is described in greater detail herein. This summary is not intended to be limiting as to the scope of the claims.

According to various embodiments, a side-by-side eliminator conveying system is disclosed herein. The side-by-side eliminator conveying system can include a guardrail, which includes a vertical side wall. Further, the side-by-side eliminator conveying system includes a first conveyor and a second conveyor. The first conveyor is adjacent to the guardrail such that the first conveyor is between the guardrail and the second conveyor.

The first conveyor includes a first conveying surface that is perpendicular to the vertical sidewall. The first conveying surface can have a first inner edge and a first outer edge. The first inner edge can be adjacent to the vertical side wall. Moreover, the second conveyor can include a second conveying surface perpendicular to the vertical side wall. The second conveying surface can have a second inner edge and a second outer edge. The second inner edge of the second conveying surface can be adjacent to the first outer edge of the first conveying surface. The second conveyor further includes a series of driven rollers. A roller in the series of driven rollers is within at least a first sleeve and a second sleeve. The first sleeve and the second sleeve are configured to rotate independently of the roller.

According to various examples, the first conveying surface and the second conveying surface can be arranged in parallel (e.g., the first conveying surface and the second conveying surface can both extend longitudinally across the side-by-side conveying system while being laterally adjacent to each other). The first conveying surface can be configured to convey a first package inputted to the side-by-side eliminator conveying system longitudinally forward along the vertical side wall. Further, the second conveying surface can be configured to convey a second package inputted to the side-by-side eliminator conveying system both longitudinally forward and laterally outward away from the vertical side wall. The side-by-side eliminator conveying system is designed so as to lack a third conveying surface of a third conveyor in parallel with the first conveying surface and the second conveying surface.

The series of driven rollers included in the second conveyor can be skewed relative to the vertical side wall such that axes of rotation of the rollers and a vertical side wall are non-perpendicular. Moreover, it is contemplated that each of the rollers in the series can be within a respective plurality of sleeves. The sleeves surrounding the rollers can have corresponding coefficients of friction and inertias based on respective sleeve length and sleeve material. Thus, the sleeves surrounding the rollers included in the side-by-side eliminator conveying system can include at least a sleeve having a first coefficient of friction and a first inertia and a differing sleeve having a differing second coefficient of friction and a differing second inertia.

Moreover, a roller assembly for a side-by-side illuminator conveying system is disclosed herein. The roller assembly includes a roller, which includes a tubular wall, a first end, and a second end. Moreover, the roller assembly can include a first sheave and a second sheave. The first sheave can be coupled to the first end of the roller such that the first sheave is partially disposed within the tubular wall at the first end of the roller. Moreover, the second sheave can be coupled to the second end of the roller such that the second sheave is partially disposed within the tubular wall at the second end of the roller. The roller assembly further includes a first sleeve and a second sleeve. The roller is within the first sleeve such that the first sleeve surrounds a first portion of the tubular wall. The roller is also within the second sleeve such that the second sleeve surrounds a second portion of the tubular wall, where the first portion of the tubular wall and the second portion of the tubular wall are non-overlapping. Further, according to various examples, the roller assembly can also include foam disposed within the roller in a volume defined by the tubular wall, the first sheave, and the second sheave.

This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a perspective view of a side-by-side eliminator conveying system.

FIG. 2 is a top view of the side-by-side eliminator conveying system of FIG. 1.

FIG. 3 is a side view of the side-by-side eliminator conveying system of FIG. 1.

FIG. 4 is a perspective view of another exemplary embodiment of a side-by-side eliminator conveying system.

FIG. 5 is a perspective view of a roller assembly for a side-by-side eliminator conveying system.

FIG. 6 is a cross-sectional view of the roller assembly of FIG. 5.

FIG. 7 is a close-up perspective view of a portion of the roller assembly of FIG. 4.

FIG. 8 is another close-up perspective view of the portion of the roller assembly of FIG. 7.

FIG. 9 is a side view of a first sheave partially disposed within tubular wall of a roller without a sleeve surrounding the roller.

### DETAILED DESCRIPTION

Various technologies pertaining to a side-by-side eliminator with sleeve covered rollers are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Terms such as “first” and “second” are used herein for identification purposes. These terms are not intended to imply any sort of order.

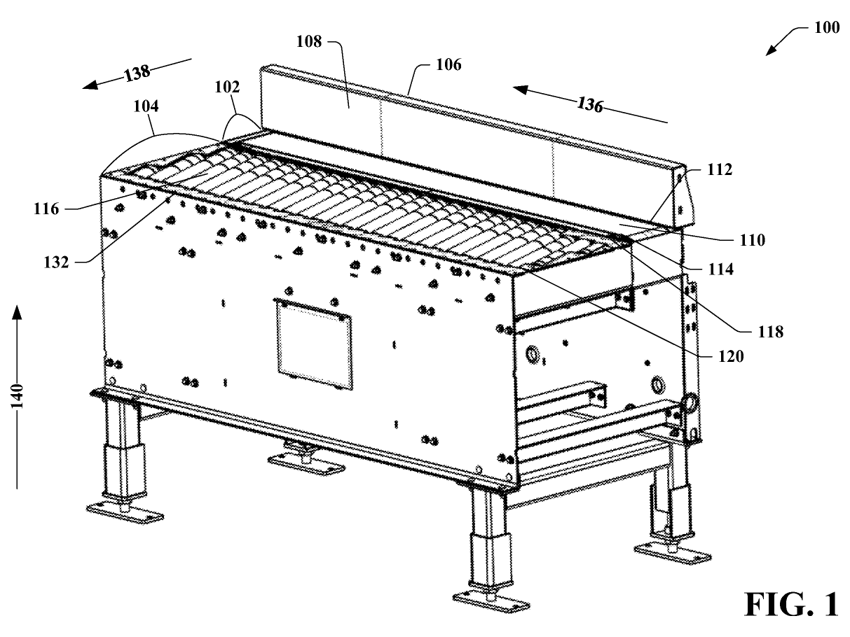

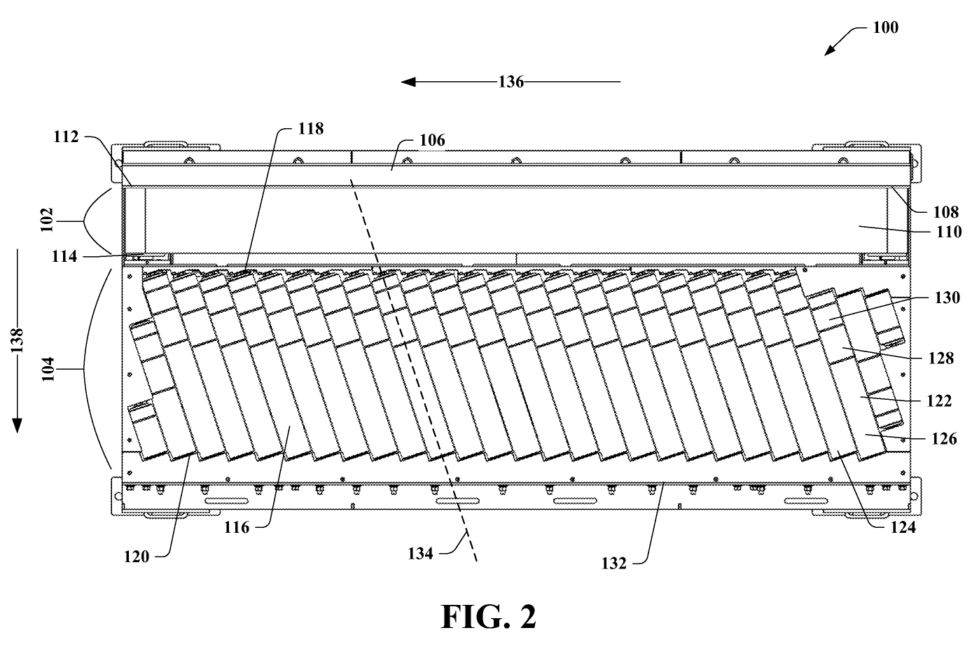

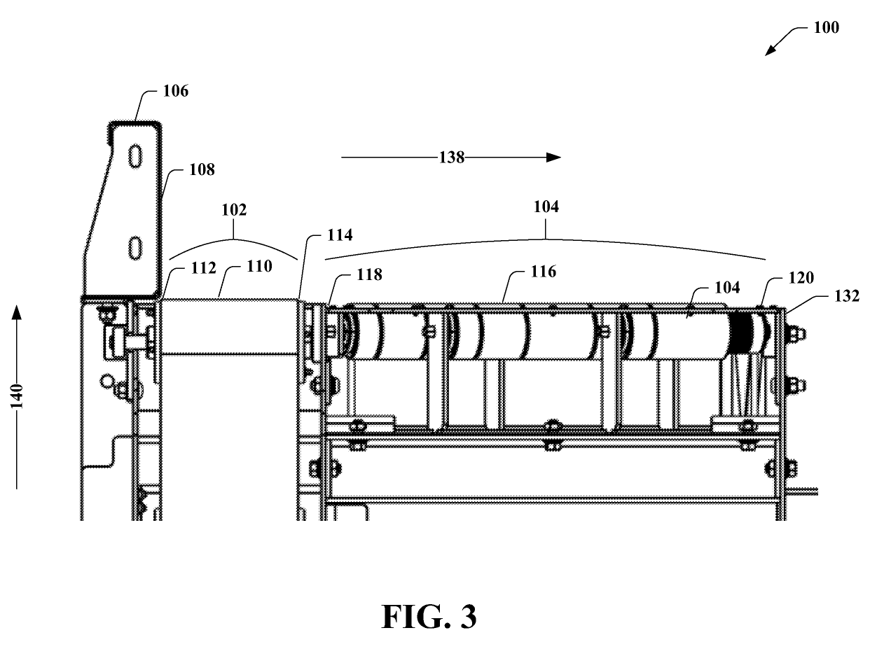

Now turning to the drawings, FIGS. 1-3 depict an exemplary embodiment of a side-by-side eliminator conveying system 100. A perspective view of the side-by-side eliminator conveying system 100 is shown in FIG. 1, a top view of the side-by-side eliminator conveying system 100 is shown in FIG. 2, and a side view of the side-by-side eliminator conveying system 100 is shown in FIG. 3.

The side-by-side eliminator conveying system 100 includes a first conveyor 102 and a second conveyor 104. Moreover, the side-by-side eliminator conveying system 100 includes a guardrail 106; the guardrail 106 includes a vertical side wall 108. The first conveyor 102 is adjacent to the guardrail 106. Further, the second conveyor 106 is adjacent to the first conveyor 104. In particular, the first conveyor 102 is between the guardrail 106 and the second conveyor 104.

The first conveyor 102 includes a first conveying surface 110. The first conveying surface 110 is perpendicular to the vertical side wall 108 of the guardrail 106 (e.g., a plane that includes the first conveying surface 110 is perpendicular to the vertical side wall 108). The first conveying surface 110 includes a first inner edge 112 and a first outer edge 114. The first inner edge 112 is adjacent to the vertical side wall 108. According to the depicted example, the first conveyor 102 can include a driven belt (e.g., the driven belt can be the first conveying surface 110). However, it is contemplated that other conveyor types of the first conveyor 102 are intended to fall within the scope of the hereto appended claims (e.g., the first conveyor 102 can include a series of driven rollers having axes that are perpendicular to the vertical side wall 108).

The second conveyor 104 includes a second conveying surface 116. The second conveying surface 116 is perpendicular to the vertical side wall 108 of the guardrail 106 (e.g., a plane that includes the second conveying surface 116 is perpendicular to the vertical side wall 108). The second conveying surface 116 includes a second inner edge 118 and a second outer edge 120. The second inner edge 118 of the second conveying surface 116 is adjacent to the first outer edge 114 of the first conveying surface 110.

The second conveyor 104 includes a series of driven rollers. The series of rollers that are part of the second conveyor 104 include a roller 122, a roller 124, and so forth. The series of rollers included in the second conveyor 104 are collectively referred to herein as rollers 122-124.

In the depicted embodiment, each of the rollers 122-124 is within a respective plurality of sleeves. The sleeves are configured to rotate independently of the rollers and of each other. Thus, a roller in the series of driven rollers 122-124 is within at least a first sleeve and a second sleeve, where the first sleeve and the second sleeve are configured to rotate independently of the roller. For instance, the roller 122 is within a first sleeve 126, a second sleeve 128, and third sleeve 130. Thus, the sleeve 126, the sleeve 128, and the sleeve 130 can each be configured to rotate independently of the roller 122. The sleeves 126-130 can also be configured to rotate independently of one another. Further, outer surfaces of the sleeves surrounding the rollers 122-124 of the second conveyor 104 can form the second conveying surface 116.

The first conveying surface 110 and the second conveying surface 116 are arranged in parallel in the side-by-side eliminator conveying system 100. The first conveying surface 110 is configured to convey a first package inputted to the side-by-side eliminator conveying system 100 longitudinally forward along the vertical side wall 108. The second conveying surface 116 is configured to convey a second package inputted to the side-by-side eliminator conveying system 100 both longitudinally forward and laterally outwardly away from the vertical side wall 108. Thus, the second conveying surface 116 of the second conveyor 104 can cause a package to be laterally conveyed over a side 132 of the side-by-side eliminator conveying system 100; the side 132 is opposite the guardrail 106.

A longitudinal direction is represented by arrow 136. A lateral direction is represented by arrow 138. A vertical direction is represented by arrow 140.

The side-by-side eliminator conveying system 100 includes two adjacent conveyors 102 and 104 between the guardrail 106 and the side 132 (e.g., the two conveyors 102 and 104 each longitudinally extend across the side-by-side eliminator 100 while being positioned laterally adjacent to each other). The side-by-side eliminator conveying system 100 lacks any other conveyors between the guardrail 106 and the side 132. Thus, the side-by-side eliminator conveying system 100 lacks a third conveying surface of a third conveyor arranged in parallel with the first conveying surface 110 of the first conveyor 102 and the second conveying surface 116 of the second conveyor 104.

Although not shown, it is contemplated that the first conveyor 102 further includes a first drive assembly configured to drive the first conveyor 102. Likewise, the second conveyor 104 includes a second drive assembly configured to drive the second conveyor 104. The drive assemblies can each include respective motors, controls, safeties, power transmissions, and the like. Thus, in contrast to conventional side-by-side eliminators that include at least three laterally adjacent conveyors, the side-by-side eliminator conveying system 100 can reduce complexity by including fewer conveyors (e.g., fewer drive assemblies, fewer components, etc.).

The series of driven rollers 122-124 included in the second conveyor 104 can be skewed relative to the vertical sidewall 108. Accordingly, axes of rotation of the rollers 122-124 and the vertical side wall 108 are non-perpendicular (e.g., non-perpendicular in the lateral direction). FIG. 2 shows the axes of rotation of the rollers 122-124 being laterally skewed relative to the vertical side wall 108 (e.g., axis of rotation 134 and the vertical side wall 108 are non-perpendicular in the lateral direction in the top view of the side-by-side eliminator conveying system 100 of FIG. 2), while FIG. 3 shows the axes of rotation of the rollers 122-124 being vertically perpendicular with the vertical side wall 108 (e.g., the axes of rotation of the rollers 122-124 are in a plane that is perpendicular to the vertical side wall 108). By way of example, the axes of rotation of the rollers 122-124 can be skewed by an angle in a range between 5 degrees and 45 degrees, an angle in a range between 10 degrees and 30 degrees, or the like. According to an illustration, the angle can be 18 degrees. The aforementioned angle can refer to an angle between the axes of rotation of the rollers 122-124 and a normal to the vertical sidewall 108 (e.g., which is oriented in the lateral direction 138).

Covers at an end of the side-by-side eliminator conveying system 100 (e.g., covers over the first conveyor 102 and the second conveyor 104) are removed in the side view illustrated in FIG. 3 so as to show the belt of the first conveyor 102 and a roller surrounded by sleeves of a second conveyor 104. As depicted, the first conveying surface 110 and the second conveying surface 116 are both perpendicular to the vertical side wall 108 of the guardrail 106. Thus, a top of the first conveying surface 110 (e.g., a portion of the first conveying surface 110 configured to contact a package) is in a plane that is vertically perpendicular with the vertical side wall 108. Likewise, a top of the second conveying surface 116 (e.g., a portion of the second conveying surface 110 configured to contact a package) is in a plane that is vertically perpendicular with the vertical side wall 108. In the example depicted in FIG. 3, the first conveying surface 110 and the second conveying surface 116 are non-coplanar; in particular, the first conveying surface 110 is vertically above the second conveying surface 116. However, in other embodiments, it is contemplated that the first conveying surface 110 and the second conveying surface 116 can be coplanar.

As noted above, the rollers 122-124 in the series included in the second conveyor 104 are within respective pluralities of sleeves. However, according to other embodiments, it is contemplated that a first subset of the rollers 122-124 can be within respective pluralities of sleeves while a second subset of the rollers 122-124 can be within a single sleeve (and/or lack a sleeve).

The sleeves surrounding the rollers 122-124 can have various lengths. For instance, some of the sleeves can have differing lengths (e.g., a length of the sleeve 126 can be longer than a length of the sleeve 128). Additionally or alternatively, some of the sleeves can have the same length.

Moreover, the sleeves surrounding the rollers 122-124 can be formed of various materials. According to an example, a first material from which a first sleeve is formed can differ from a second material from which a second sleeve is formed. Additionally or alternatively, some (or all) of the sleeves surrounding the rollers 122-124 can be formed of a common material.

Further, the rollers 122-124 can have a common number of sleeves across their respective lengths and/or a differing number of sleeves across their respective lengths. As depicted in the example of FIGS. 1-2, some of the rollers 122-124 have four sleeves across the lengths of the rollers, while other rollers have two sleeves across the lengths. It is to be appreciated, however, that the claimed subject matter is not so limited. For instance, it is contemplated that two rollers each having a substantial similar length can have differing numbers of sleeves across their respective lengths.

The sleeves surrounding the rollers can have corresponding coefficients of friction and inertias based on respective sleeve length and sleeve material. Sleeves included in the second conveyor 104 can include at least a sleeve having a first coefficient of friction and a first inertia and a differing sleeve having a differing second coefficient of friction and differing second inertia. Accordingly, each of the sleeves can have a corresponding length and be formed of a specifically selected material. The lengths and the types of materials can vary across the second conveying surface 116.

Varying the lengths of the sleeves across the rollers 122-124 of the second conveying surface 116 can allow for tailoring overall roller inertia or power transmission on a package being conveyed by the side-by-side eliminator conveying system 100. Varying the lengths of the sleeves can directly impact inertia of the sleeves, which can provide control over power transmission.

Further, examples of materials from which the sleeves can be formed include Ultrex, ultra high molecular weight polyethylene (UHMW), polyurethane coating, Durasurf, Teflon, and the like. The differing types of material can provide different coefficients of friction. The differences in friction can allow for tailoring overall power transmission on a package being conveyed by the side-by-side eliminator conveying system 100. For instance, varying a coefficient of friction of a sleeve (e.g., a section across a length of a roller) can directly impact package inertia providing control over power transmission to the package.

Pursuant to various embodiments, the lengths of the sleeves, the numbers of sleeves on each of the rollers 122-124, and/or the materials from which the sleeves are formed can be varied across the second conveying surface 116 depending on type(s) of packages being conveyed by the side-by-side eliminator conveying system 100, throughput of the side-by-side eliminator conveying system 100, speed at which the side-by-side eliminator conveying system 100 is operating, and/or a combination thereof. Accordingly, properties of the sleeves can be selected depending on characteristics of the packages being handled and/or characteristics of the flow of packages (e.g., speed, throughput). Thus, in contrast to conventional side-by-side eliminators which are static in nature, the side-by-side eliminator conveying system 100 can be tuned for different types of packages and/or operating parameters.

As noted above, a package singulation system can be upstream of the side-by-side eliminator conveying system 100. The package singulation system can attempt to arrange the packages in a single file line and can input a stream of packages to the side-by-side eliminator conveying system 100. The first conveyor 102 can longitudinally convey the packages aligned in the single file line against the guardrail 106 downstream from the side-by-side eliminator conveying system 100. Further, the second conveyor 104 can laterally remove the packages that are not aligned in the single file line over the side 132, causing such packages to be recirculated to an earlier portion of the overall conveyor system for another opportunity to be aligned as part of the single file line.

Pursuant to various examples, the vertical side wall 108 can be a painted surface. According to another example, the vertical side wall 108 can be coated with a material having a low coefficient of friction. Friction differences between the vertical side wall 108 and the first conveying surface 110, for instance, can aid in aligning packages being conveyed by the first conveyor 102. Pursuant to another example, the vertical side wall 108 can be coated with a material having a high coefficient of friction (e.g., to limit pull on a package caused by the sleeves).

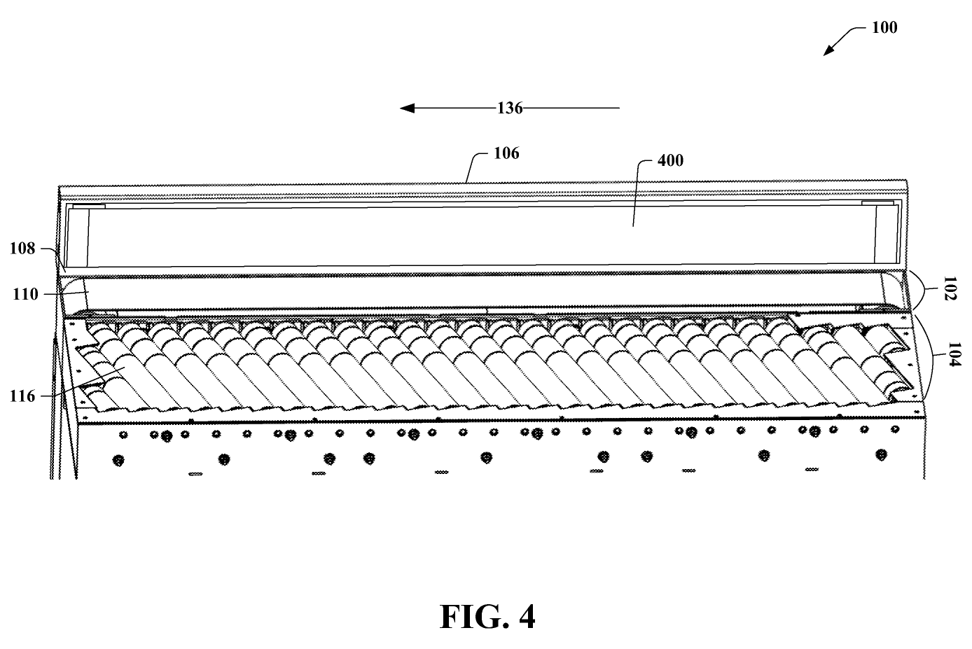

Now referring to FIG. 4, illustrated is another exemplary embodiment of the side-by-side eliminator conveying system 100. In the example shown in FIG. 4, the vertical side wall 108 of the guardrail 106 further includes a third conveying surface 400 of a third conveyor. A top of the third conveying surface 400 (e.g., a portion of the third conveying surface 400 configured to contact a package) is in a plane that is perpendicular to a plane in which the top of the first conveying surface 110 is disposed. Likewise, the top of the third conveying surface 400 is in a plane that is perpendicular to a plane in which the top of the second conveying surface 116 is disposed. The third conveyor can include a driven vertical belt (e.g., the third conveying surface 400 can be the driven vertical belt). The third conveying surface 400 included as part of the vertical side wall 108 can assist in aligning packages being conveyed by the first conveyor 102 (e.g., aid in squareness of such packages included in a single file line). For instance, the third conveying surface 400 can provide friction with a package that has been aligned to the vertical side wall 108 so as to mitigate such aligned package from being removed from the single file line by the second conveyor 106.

The rollers 122-124 and sleeves included in the second conveyor 104 of the side-by-side eliminator conveying system 100 are now described herein in greater detail. As used herein, the term “roller assembly” refers to a roller surrounded by sleeves; thus, the second conveyor 104 includes a series of roller assemblies.

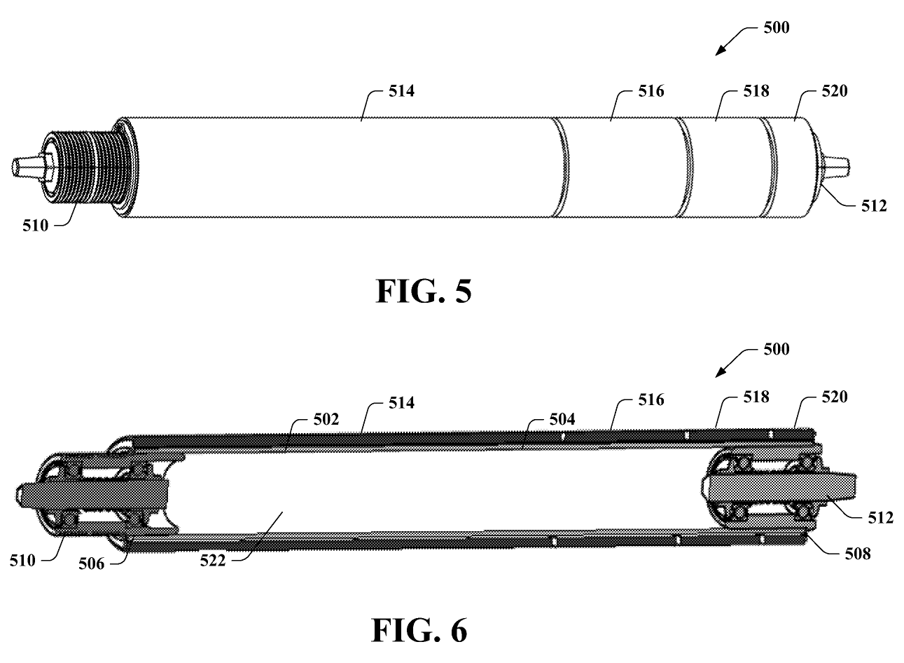

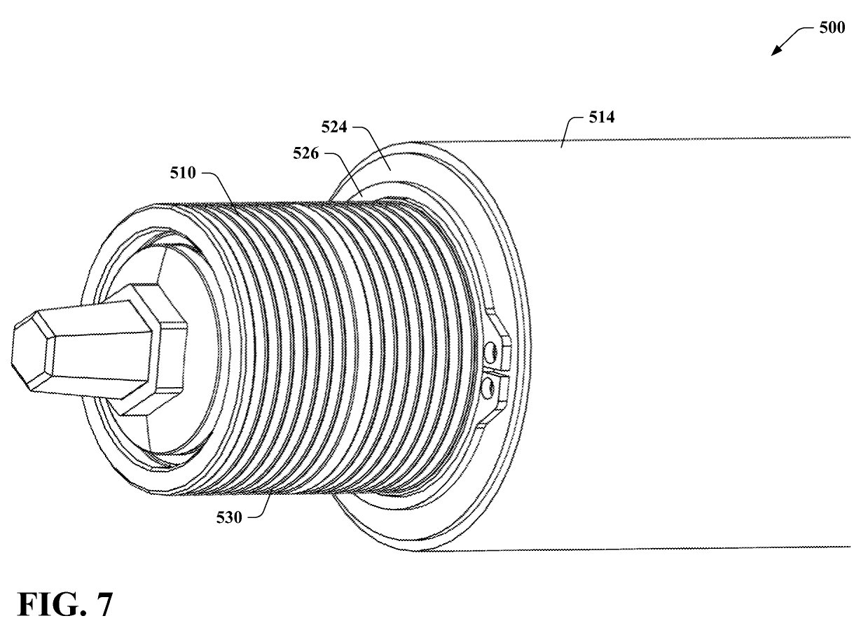

FIG. 5 depicts a perspective view of a roller assembly 500 for a side-by-side eliminator conveying system (e.g., the side-by-side eliminator conveying system 100). Moreover, FIG. 6 depicts a cross-sectional view of the roller assembly 500 of FIG. 5. The roller assembly 500 includes a roller 502 (e.g., one of the rollers 122-124). The roller 502 includes a tubular wall 504, a first end 506, and a second end 508 opposite the first end 506. The tubular wall 504 can be a steel tube, for instance. The roller assembly 500 further includes a first sheave 510 and a second sheave 512. The first sheave 510 is coupled to the first end 506 of the roller 502; the first sheave 510 is partially disposed within the tubular wall 504 at the first end 506. Moreover, the second sheave 512 is coupled to the second end 508 of the roller 502; the second sheave 512 is partially disposed within the tubular wall 504 at the second end 508. The first sheave 510 and the second sheave 512 can be cartridges insertable into the tubular wall 504. While referred to as the first sheave 510 and the second sheave 512 herein, it is contemplated that either or both of elements 510 and 512 can instead be referred to as cartridges (cartridge 510 and/or cartridge 512 need not be a sheave).

Moreover, the roller assembly 500 includes a plurality of sleeves across a length of the roller 502. The sleeves surround the roller 502 and are configured to rotate independently of the roller 502. The sleeves are non-overlapping along the length of the roller 502. In the depicted example, four sleeves are across the length of the roller 502, namely, a first sleeve 514, a second sleeve 516, a third sleeve 518, and a fourth sleeve 520. The sleeves 514-520 are free floating along the length of the roller 502 with designed in clearances between each of the sleeves 514-520. While the roller assembly 500 includes four sleeves 514-520, it is contemplated that a roller assembly can include two or more sleeves and, thus, is not limited to including four sleeves 514-520.

The roller 502 is within the first sleeve 514 such that the first sleeve 514 surrounds a first portion of the tubular wall 504. Likewise, the roller 502 is within the second sleeve 516 such that the second sleeve 516 surrounds a second portion of the tubular wall 504, where the first portion of the tubular wall 504 and the second portion of the tubular wall 504 are non-overlapping. The roller 502 is likewise within the third sleeve 518 and the fourth sleeve 520 in the depicted example; thus, the third sleeve 518 surrounds a third portion of the tubular wall 504 and the fourth sleeve 520 surrounds a fourth portion of the tubular wall 504, where the first portion, second portion, third portion, and the fourth portion of the tubular wall 504 are all non-overlapping. As illustrated, a length of the first sleeve 514 is greater than a length of the second sleeve 516, the length of the second sleeve 516 is greater than a length of the third sleeve 518, and the length of the third sleeve 518 is greater than a length of the fourth sleeve 520. However, it is contemplated that substantially any sleeve lengths are intended to fall within the scope of the hereto appended claims. For instance, in another example, it is contemplated that a length of the first sleeve 514 and a length of the second sleeve 516 can be the same. Moreover, in yet other examples, it is to be appreciated the positioning of the sleeves of different lengths need not be in the order shown in FIGS. 5-6 (e.g., decreasing lengths across the roller assembly 500 from the first end 506 to the second end 508). Thus, for example, the length of the first sleeve 514 adjacent to the first sheave 510 can be less than the length of the second sleeve 516 disposed at a distance from the first sheave 510.

Moreover, the sleeves 514-520 can be formed of various materials. According to an example, the first sleeve 514 and the second sleeve 516 can be formed of the same material. Pursuant to a different example, the first sleeve 514 and the second sleeve 516 can be formed of differing materials.

The sleeves 514-520 can each have a corresponding coefficient of friction and inertia based on respective sleeve length and sleeve material. Thus, the length of each of the sleeves 514-520 and the type of material from which each of the sleeves 514-520 is formed can be selected based on desired coefficients of friction and inertias of the sleeves 514-520; the coefficients of friction and the inertias can be tailored based on characteristics of packages to be conveyed by the side-by-side eliminator conveying system. Moreover, the number of sleeves along a length of the roller 502 can be tailored based on characteristics of the packages to be conveyed. Further, it is contemplated that the number of sleeves along the roller, the lengths of each of the sleeves, and the materials from which each of the sleeves is formed can vary from roller assembly to roller assembly in the series of roller assemblies of the second conveyor 104 of the side-by-side eliminator conveying system 100.

According to various examples, the rollers included in the second conveyor 104 can be filled with foam. More specifically, the roller assembly 500 can include foam 522 disposed within the roller 502 in a volume defined by the tubular wall 504, the first sheave 510, and the second sheave 512. The foam 522 filling the aforementioned volume within the roller 502 can aid in reducing generated sound. Thus, the roller assemblies of the second conveyor 104 can be filled with foam to reduce sound generated by such roller assemblies of the second conveyor 104 of the side-by-side eliminator conveying system 100.

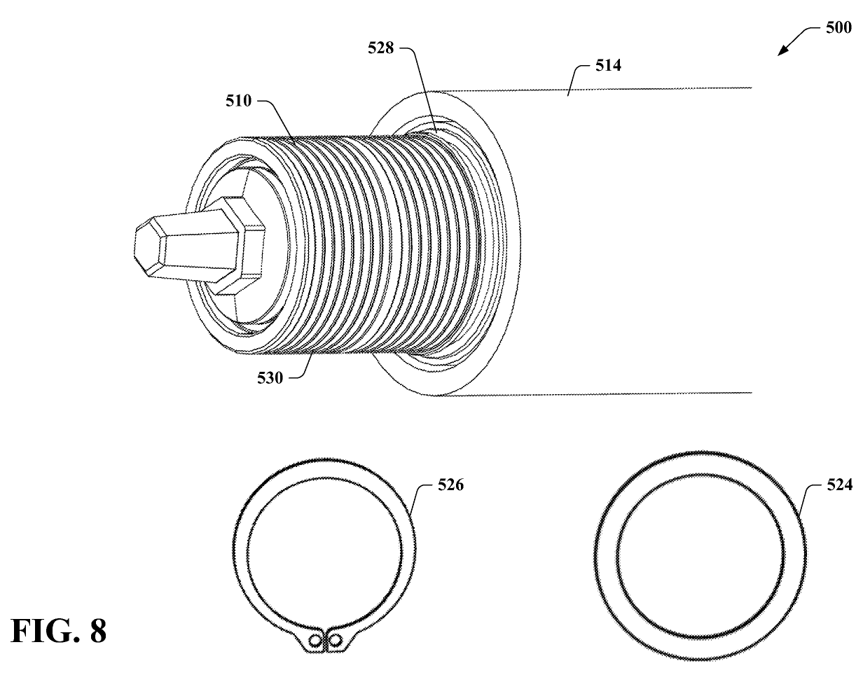

Now referring to FIG. 7, illustrated is a close-up perspective view of a portion of the roller assembly 500 including the first sheave 510 and the first sleeve 514. As noted above, the first sheave 510 is partially disposed within the roller 502, and the first sleeve 514 surrounds the roller 502. The roller assembly 500 can further include a retaining washer 524 and a snap ring 526; the snap ring 526 and the retaining washer 524 can retain the first sleeve 514 (as well as the other sleeve(s) surrounding the roller 502) on the roller 502. The snap ring 526 and the retaining washer 524 can be removably positioned on the first sheave 510.

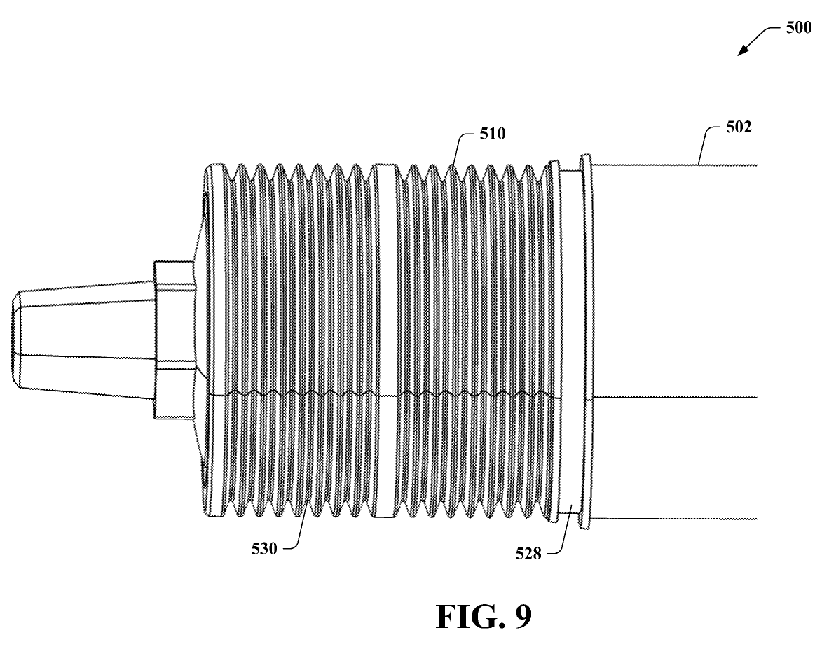

As depicted in FIG. 8, the snap ring 526 and the retaining washer 524 are removed from the first sheave 510. As illustrated in FIG. 8, the first sheave 510 includes a groove 528 formed in an outer surface of the first sheave 510. When the first sheave 510 is partially disposed within the tubular wall 504 of the roller 502 at the first end 506, the groove 528 of the first sheave 510 is positioned outside of the tubular wall 504. Thus, the retaining washer 524 can positioned around the portion of the first sheave 510 disposed outside of the tubular wall 504 of the roller 502 and adjacent to the first sleeve 514. Further, the snap ring 526 can be positioned around the portion of the first sheave 510 and in the groove 528 of the first sheave 510 such that the snap ring 526 can retain the retaining washer 524, the first sleeve 514 (as well as the other sleeve(s) surrounding the roller 502). The snap ring 526 is removably positioned in the groove 528 (e.g., the snap ring 526 can be removed from the groove 528 and off of the first sheave 510 to enable sliding the retaining washer 524 as well as one or more of the sleeves 514-520 off of the roller 502).

FIG. 9 depicts a side view of the first sheave 510 partially disposed within the tubular wall 504 of the roller 502 without a sleeve surrounding the roller 502. Again, the sheave 510 includes the groove 528 formed in the outer surface. It is to be appreciated that the second sheave 512 can likewise include a similar groove formed in the outer surface of the second sheave 512. Accordingly, a second retaining washer and a second snap ring can be removably positioned on the second sheave 512. More specifically, the second retaining washer can be positioned around the portion of the second sheave 512 disposed outside of the tubular wall 502 of the roller (e.g., adjacent to the fourth sleeve 520 in the example of FIGS. 5-6) and the second snap ring can be positioned around the portion of the second sheave 512 and in the groove of the second sheave 512 such that the second snap ring can retain the second retaining washer, the fourth sleeve 520 (as well as the other sleeve(s) surrounding the roller 502). Similar to the snap ring 526, the second snap ring can be removably positioned in the groove of the second sheave 512.

According to an example, the roller assembly 500 can be designed such that one or more of the sleeves 514-520 can be swapped out from one or both of the ends. For instance, the snap ring 526 and retaining washer 524 can be removed from the first sheave 510 and/or the snap ring and retaining washer can be removed from the second sheave 512 to allow for one or more of the sleeves 514-520 to be slid off of the roller 502 and replaced with other sleeve(s) that can be slid onto the roller 502. Thereafter, the retaining washers and snap rings can be repositioned such that they retain the sleeves from both ends 506-508.

Moreover, the first sheave 510 can further include a plurality of V-shaped grooves 530 formed in the outer surface of the first sheave 510. Accordingly, a belt coupled to at least a subset of the V-shaped grooves 530 can drive the roller assembly 500. Thus, the roller assembly 500 can be driven with a torque transmitting cartridge (e.g., the first sheave 510). Since the sleeves 514-520 surround the roller 502, it is to be appreciated that the roller assembly 500 cannot be driven from underneath the roller assembly 500 by pressing on the sleeves 514-520. Further, the second sheave 512 can lack V-shaped grooves formed on the outer surface of the second sheave 512; thus, the roller assembly 500 can be driven from one end (e.g., the first sheave 510) and not the opposite end (e.g., the second sheave 512).

Described herein are various technologies according to at least the following examples.

(A1) In an aspect, a side-by-side eliminator conveying system includes a guardrail, a first conveyor, and a second conveyor. The guardrail includes a vertical side wall. The first conveyor is adjacent to the guardrail. The first conveyor includes a first conveying surface perpendicular to the vertical side wall. Moreover, the first conveying surface has a first inner edge and a first outer edge, where the first inner edge is adjacent to the vertical side wall. The second conveyor is adjacent to the first conveyor. The second conveyor includes a second conveying surface perpendicular to the vertical side wall. The second conveying surface has a second inner edge and a second outer edge, where the second inner edge is adjacent to the first outer edge of the first conveying surface. The second conveyor further includes a series of driven rollers, where a roller in the series of driven rollers is within at least a first sleeve and a second sleeve. The first sleeve and the second sleeve are configured to rotate independently of the roller.

(A2) In some embodiments of the side-by-side eliminator conveying system of (A1), the first conveying surface and the second conveying surface are arranged in parallel. The first conveying surface is configured to convey a first package inputted to the side-by-side eliminator conveying system longitudinally forward along the vertical side wall, and the second conveying surface is configured to convey a second package inputted to the side-by-side eliminator conveying system both longitudinally forward and laterally outwardly away from the vertical side wall.

(A3) In some embodiments of the side-by-side eliminator conveying system (A2), the side-by-side eliminator conveying system lacks a third conveying surface of a third conveyor arranged in parallel with the first conveying surface and the second conveying surface.

(A4) In some embodiments of the side-by-side eliminator conveying system of at least one of (A1)-(A3), the first conveyor includes a driven belt.

(A5) In some embodiments of the side-by-side eliminator conveying system of at least one of (A1)-(A4), the series of driven rollers are skewed relative to the vertical side wall such that axes of rotation of the rollers and the vertical side wall are non-perpendicular.

(A6) In some embodiments of the side-by-side eliminator conveying system of at least one of (A1)-(A5), each of the rollers in the series is within a respective plurality of sleeves.

(A7) In some embodiments of the side-by-side eliminator conveying system of (A6), each of the plurality of sleeves surrounding each of the rollers has a corresponding coefficient of friction and inertia based on respective sleeve length and sleeve material, and the plurality of sleeves includes at least a sleeve having a first coefficient of friction and a first inertia and a differing sleeve having a differing second coefficient of friction and a differing second inertia.

(A8) In some embodiments of the side-by-side eliminator conveying system of at least one of (A1)-(A7), the first conveying surface and the second conveying surface are non-coplanar such that the first conveying surface is higher than the second conveying surface.

(A9) In some embodiments of the side-by-side eliminator conveying system of at least one of (A1)-(A7), the first conveying surface and the second conveying surface are coplanar.

(A10) In some embodiments of the side-by-side eliminator conveying system of at least one of (A1)-(A9), the vertical side wall of the guardrail includes a third conveying surface of a third conveyor, and the third conveyor includes a driven vertical belt.

(A11) In some embodiments of the side-by-side eliminator conveying system of at least one of (A1)-(A9), the vertical side wall is coated with a material having a low coefficient of friction.

(A12) In some embodiments of the side-by-side eliminator conveying system of at least one of (A1)-(A11), a first length of the first sleeve differs from a second length of the second sleeve.

(A13) In some embodiments of the side-by-side eliminator conveying system of at least one of (A1)-(A12), a first material from which the first sleeve is formed differs from a second material from which the second sleeve is formed.

(A14) In some embodiments of the side-by-side eliminator conveying system of at least one of (A1)-(A13), the rollers are filled with foam.

(B1) In yet another aspect, a roller assembly for a side-by-side eliminator conveying system includes a roller, a first sheave, a second sheave, a first sleeve, and a second sleeve. The roller includes a tubular wall, a first end, and a second end. The first sheave is coupled to the first end of the roller, where the first sheave is partially disposed within the tubular wall at the first end. The second sheave is coupled to the second end of the roller, where the second sheave is partially disposed within the tubular wall at the second end. The roller is within the first sleeve such that the first sleeve surrounds a first portion of the tubular wall. Further, the roller is within the second sleeve such that the second sleeve surrounds a second portion of the tubular wall. The first portion of the tubular wall and the second portion of the tubular wall are non-overlapping.

(B2) In some embodiments of the roller assembly of (B1), the roller assembly further includes foam disposed within the roller in a volume defined by the tubular wall, the first sheave, and the second sheave.

(B3) In some embodiments of the roller assembly of at least one of (B1)-(B2), the roller assembly further includes at least a third sleeve, where the roller is within the third sleeve such that the third sleeve surrounds a third portion of the tubular wall, and where the first portion of the tubular wall, the second portion of the tubular wall, and the third portion of the tubular wall are non-overlapping.

(B4) In some embodiments of the roller assembly of at least one of (B1)-(B3), the first sheave includes a groove formed in an outer surface of the first sheave, where the first sheave is partially disposed within the tubular wall at the first end such that the groove of the first sheave is positioned outside of the tubular wall. The roller assembly further includes a retaining washer and a snap ring, where the snap ring is removably positioned in the groove of the first sheave such that the snap ring retains the retaining washer, the first sleeve, and the second sleeve.

(B5) In some embodiments of the roller assembly of (B4), the first sheave further includes a plurality of V-shaped grooves formed in the outer surface of the first sheave.

(B6) In some embodiments of the roller assembly of at least one of (B1)-(B5), the first sleeve and the second sleeve each have a corresponding coefficient of friction and inertia based on respective sleeve length and sleeve material.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A side-by-side eliminator conveying system, comprising:
a guardrail comprising a vertical side wall;
a first conveyor adjacent to the guardrail, the first conveyor comprising a first conveying surface perpendicular to the vertical side wall, the first conveying surface having a first inner edge and a first outer edge, wherein the first inner edge is adjacent to the vertical side wall; and
a second conveyor adjacent to the first conveyor, the second conveyor comprising a second conveying surface perpendicular to the vertical side wall, the second conveying surface having a second inner edge and a second outer edge, wherein the second inner edge is adjacent to the first outer edge of the first conveying surface;
wherein the second conveyor comprises a series of driven rollers, wherein a roller in the series of driven rollers is within at least a first sleeve and a second sleeve, and wherein the first sleeve and the second sleeve are configured to rotate independently of the roller.

2. The side-by-side eliminator conveying system of claim 1, wherein the first conveying surface and the second conveying surface are arranged in parallel, the first conveying surface is configured to convey a first package inputted to the side-by-side eliminator conveying system longitudinally forward along the vertical side wall, and the second conveying surface is configured to convey a second package inputted to the side-by-side eliminator conveying system both longitudinally forward and laterally outwardly away from the vertical side wall.

3. The side-by-side eliminator conveying system of claim 2, wherein the side-by-side eliminator conveying system lacks a third conveying surface of a third conveyor arranged in parallel with the first conveying surface and the second conveying surface.

4. The side-by-side eliminator conveying system of claim 1, wherein the first conveyor comprises a driven belt.

5. The side-by-side eliminator conveying system of claim 1, wherein the series of driven rollers are skewed relative to the vertical side wall such that axes of rotation of the rollers and the vertical side wall are non-perpendicular.

6. The side-by-side eliminator conveying system of claim 1, wherein each of the rollers in the series is within a respective plurality of sleeves.

7. The side-by-side eliminator conveying system of claim 6, wherein each of the plurality of sleeves surrounding each of the rollers has a corresponding coefficient of friction and inertia based on respective sleeve length and sleeve material, and wherein the plurality of sleeves comprises at least a sleeve having a first coefficient of friction and a first inertia and a differing sleeve having a differing second coefficient of friction and a differing second inertia.

8. The side-by-side eliminator conveying system of claim 1, wherein the first conveying surface and the second conveying surface are non-coplanar such that the first conveying surface is higher than the second conveying surface.

9. The side-by-side eliminator conveying system of claim 1, wherein the first conveying surface and the second conveying surface are coplanar.

10. The side-by-side eliminator conveying system of claim 1, wherein the vertical side wall of the guardrail comprises a third conveying surface of a third conveyor, the third conveyor comprises a driven vertical belt.

11. The side-by-side eliminator conveying system of claim 1, wherein the vertical side wall is coated with a material having a low coefficient of friction.

12. The side-by-side eliminator conveying system of claim 1, wherein a first length of the first sleeve differs from a second length of the second sleeve.

13. The side-by-side eliminator conveying system of claim 1, wherein a first material from which the first sleeve is formed differs from a second material from which the second sleeve is formed.

14. The side-by-side eliminator conveying system of claim 1, wherein the rollers are filled with foam.

15. A roller assembly for a side-by-side eliminator conveying system, comprising:
a roller, wherein the roller comprises a tubular wall, a first end, and a second end;
a first sheave coupled to the first end of the roller, wherein the first sheave is partially disposed within the tubular wall at the first end;
a second sheave coupled to the second end of the roller, wherein the second sheave is partially disposed within the tubular wall at the second end;
a first sleeve, wherein the roller is within the first sleeve such that the first sleeve surrounds a first portion of the tubular wall; and
a second sleeve, wherein the roller is within the second sleeve such that the second sleeve surrounds a second portion of the tubular wall, and wherein the first portion of the tubular wall and the second portion of the tubular wall are non-overlapping.

16. The roller assembly of claim 15, further comprising foam disposed within the roller in a volume defined by the tubular wall, the first sheave, and the second sheave.

17. The roller assembly of claim 15, further comprising at least a third sleeve, wherein the roller is within the third sleeve such that the third sleeve surrounds a third portion of the tubular wall, and wherein the first portion of the tubular wall, the second portion of the tubular wall, and the third portion of the tubular wall are non-overlapping.

18. The roller assembly of claim 15, wherein:
the first sheave comprises a groove formed in an outer surface of the first sheave, wherein the first sheave is partially disposed within the tubular wall at the first end such that the groove of the first sheave is positioned outside of the tubular wall; and
the roller assembly further comprising:
a retaining washer; and
a snap ring, wherein the snap ring is removably positioned in the groove of the first sheave such that the snap ring retains the retaining washer, the first sleeve, and the second sleeve.

19. The roller assembly of claim 18, wherein the first sheave further comprises a plurality of V-shaped grooves formed in the outer surface of the first sheave.

20. The roller assembly of claim 15, wherein the first sleeve and the second sleeve each have a corresponding coefficient of friction and inertia based on respective sleeve length and sleeve material.
